(19) United States
(12) Patent Application Publication
(10) Pub. No.: US 2009/0065615 A1
(43) Pub. Date: Mar. 12, 2009

(54) Electromagnetic Actuator and Fuel Injection Device

(76) Inventors: Hiroshi Mizui, Kanagawa (JP); Yusuke Itabashi, Kanagawa (JP); Toshio Karasawa, Kanagawa (JP)

Correspondence Address: STAAS & HALSEY LLP, SUITE 700, 1201 NEW YORK AVENUE, N.W., WASHINGTON, DC, 20005, US

(21) Appl. No.: 12/225,679

(22) PCT Filed: Mar. 23, 2007
(86) PCT No.: PCT/JP2007/055951

§ 371 Date: Sep. 26, 2008

(30) Foreign Application Priority Data
Mar. 29, 2006 (JP) 2006-090231

(51) Int. Cl. F02M 51/06; H02K 33/02; F16K 31/06

(52) U.S. Cl. 239/585.4; 310/15; 251/129.15

(57) ABSTRACT

[Problem] To reduce the size, lower the cost and increase and flatten the thrust of an electromagnetic actuator in which a plunger moves reciprocally.

[Solution] The electromagnetic actuator comprises a yoke 130, a coil 180 arranged around the yoke, an armature 120 slidably arranged inside the yoke and integrally formed with a plunger 110, and a return spring 150 for returning the armature to a rest position, wherein the yoke 130 has, in a predetermined position on the axial direction L, a thickness-reduced annular gap groove 133 over part of an outer peripheral face 131, the thickness-reduced portion having a trapezoidal cross section widening outwards. Such a constitution allows shortening the magnetic path, allows increasing and flattening the electromagnetic force (thrust) generated for the displacement of the armature, allows increasing the acceleration (responsiveness) of the armature, and allows, for instance, reducing the parts count, simplifying assembly operations, and achieving cost reductions, while requiring no high-precision control of assembly positions.

### TECHNICAL FIELD

The present invention relates to an electromagnetic actuator comprising a reciprocating plunger, and to a fuel injection device which uses this electromagnetic actuator as a drive source and which injects fuel into the intake channel of an engine, and more particularly to an electromagnetic actuator and a fuel injection device used in a small engine installed in a two-wheel vehicle or the like.

### BACKGROUND ART

Known electronic-control type fuel injection devices installed in two-wheel vehicles and the like include fuel injection devices arranged in an intake pipe or the like at a position lower than a fuel tank, wherein the fuel injection device injects, through a fuel injection nozzle, fuel led out of the fuel tank and pressure-fed by an electromagnetically driven plunger pump, the excess fuel and the generated vapor being returned to the fuel tank via a return pipe.

Such a fuel injection device (see, for instance, Patent reference 1 and Patent reference 2) comprises, among other elements, a plunger pump as an electromagnetic actuator that in turn comprises, for instance, a plunger for pressure-feeding and aspirating fuel through a reciprocating motion, a tubular armature moving integrally with the plunger, a tubular inner yoke arranged split in two around the armature, for securing the air gap, an excitation coil arranged around the inner yoke, an outer yoke and an end yoke arranged around the coil, the fuel injection device comprising also a barrel that demarcates a pressure-feeding chamber where the plunger is slidably housed; an inlet check valve for controlling the supply of fuel from a fuel supply channel into the pressure-feeding chamber; a spill valve for discharging from the pressure-feeding chamber excess fuel and generated vapor; a return channel formed outside the inner yoke and inside the coil, for returning to the fuel tank excess fuel and generated vapor; and an injection nozzle for injecting the fuel discharged from the pressure-feeding chamber.

In such a fuel injection device, however, the thrust of the plunger exhibits an increased characteristic as a result of the increased travel of the plunger, arising from the relationship of the split between inner yoke and the armature; in order to eliminate variation between devices and to obtain a predetermined thrust, therefore, it becomes then necessary to perform high-precision control of the position of the plunger or the armature during assembly. Such a fuel injection device is also problematic in that, since the inner yoke comprises two parts, component management and assembly operations, among others, become more burdensome, with increased associated costs.

Such a fuel injection device is also problematic in that, since the return channel is provided between the inner yoke and the coil, and since the outer yoke and the end yoke extend beyond the pressure-feeding chamber up to the vicinity of the injection nozzle, the overall magnetic path becomes longer, with a large associated magnetic loss (poor magnetic efficiency).

Another problem is the relatively large inlet check valve, the structure of which protrudes beyond the outer diameter of the inner yoke in a perpendicular direction to the reciprocal motion direction of the plunger, and which results in worse assemblability, larger device outline, restricted engine mounting positions, and smaller degree of freedom as regards device fitting.

[Patent reference 1] Japanese Unexamined Patent Application Laid-open No. 2002-155828

[Patent reference 2] Japanese Unexamined Patent Application Laid-open No. 2003-166455

### DISCLOSURE OF THE INVENTION

### Problems to be Solved by the Invention

In light of the above problems of conventional technology, an object of the present invention is to provide an electromagnetic actuator, and a fuel injection device having such an electromagnetic actuator as a drive source, that allow increasing and flattening the electromagnetic force (drive force or thrust), enhance responsiveness, enhance productivity, reduce power consumption and carry out high-precision stable fuel injection, while affording a reduced parts count, a simpler structure, a smaller outline, lower costs and improved assemblability, among other benefits.

### Means for Solving the Problems

The electromagnetic actuator of the present invention comprises a tubular yoke, an excitation coil arranged around the yoke, an armature slidably arranged inside the yoke, and a return spring for returning the armature to a rest position, the electromagnetic actuator driving a plunger integrally with the armature, wherein the yoke has, at a predetermined position in the axial direction, a thickness-reduced annular gap groove over part of the outer periphery of the yoke, the annular gap groove having a trapezoidal cross section widening outwards.

In the above constitution, the tubular yoke is not split in two, as in a conventional case, but is formed as one component, with the air gap formed as the annular gap groove of trapezoidal cross section on the outer peripheral face of the yoke, while, in addition, the armature is slidably supported directly on the tubular yoke; as a result, this allows shortening the magnetic path and allows increasing and flattening the electromagnetic force (thrust) generated for the displacement of the armature. The foregoing allows, in consequence, increasing the acceleration (responsiveness) of the armature, makes it unnecessary to control with high precision the relative assembly positions of the armature and the yoke, and allows, for instance, reducing the parts count, simplifying assembly operations, and achieving cost reductions.

In the electromagnetic actuator having the above constitution, the armature may also have an annular diameter-reducing portion, formed protruding in the axial direction, removed from and facing toward the wall face that demarcates the bottom of the annular gap groove when the armature is in the rest position.

In such a constitution, the annular diameter-reducing portion of the armature faces inside the (wall face that demarcates the bottom of the) annular gap groove of the yoke, with just a small gap in between; this allows curbing magnetic loss and increasing further the generated electromagnetic force (thrust).

The electromagnetic actuator having the above constitution may have a second yoke arranged outside the tubular yoke and the coil, the second coil being provided in a range not protruding beyond the tubular yoke in the axial direction of the tubular yoke.

In such a constitution, the second yoke (for instance, an outer yoke when the tubular yoke is an inner yoke) is set to have a length in the axial direction equal to or shorter than that of the tubular yoke, which as a result allows setting a shorter overall magnetic path length, reducing magnetic loss, and further enhancing the generated magnetic force (thrust).

In the electromagnetic actuator having the above constitution, the armature and the plunger may be integrally molded from the same material.

Such a constitution molded out of a same material allows reducing, for instance, the number of mounting operations, the parts count and overall costs.

The fuel injection device according to the present invention comprises: an electromagnetic actuator having a plunger for aspirating fuel into a pressure-feeding chamber and for pressure-feeding the fuel through a reciprocating motion, a supply channel for feeding the fuel to the pressure-feeding chamber, a return channel for returning part of the supplied fuel, an armature moving integrally with the plunger to electromagnetically drive the plunger, a tubular yoke for slidably housing the armature, an excitation coil arranged around the yoke, and a return spring for returning the armature to a rest position; and an injection nozzle for injecting the fuel discharged from the pressure-feeding chamber, wherein the yoke has, at a predetermined position in the axial direction, a thickness-reduced annular gap groove over part of the outer periphery of the yoke, the annular gap groove having a trapezoidal cross section widening outwards.

In the above constitution, the tubular yoke is not split in two, as in a conventional case, but is formed as one component, with the air gap formed as the annular gap groove of trapezoidal cross section on the outer peripheral face of the tubular yoke, while, in addition, the armature is slidably supported directly on the tubular yoke.

This allows, therefore, shortening the magnetic path and allows increasing and flattening the electromagnetic force (thrust) generated for the displacement of the armature, allows increasing the acceleration (responsiveness) of the armature and the plunger, i.e., reducing the time required by the pressurization stroke. Therefore, if the discharge characteristic is good as in a conventional case, power consumption can be reduced by shrinking the drive pulse width, while, on the other hand, discharge (injection) precision can be increased by setting a drive pulse width as in a conventional case. Also, there is no need to perform high-precision control of the relative assembly positions of the armature and the yoke, which allows, for instance, reducing the parts count and simplifying the assembly operations, as well as reducing costs.

In the fuel injection device having the above constitution, the armature may also have an annular diameter-reducing portion, formed protruding in the axial direction, removed from and facing toward the wall face that demarcates the bottom of the annular gap groove when the armature is in the rest position.

In such a constitution, the annular diameter-reducing portion of the armature faces inside the (wall face that demarcates the bottom of the) annular gap groove of the yoke, with just a small gap in between; this allows curbing magnetic loss and increasing further the generated electromagnetic force (thrust). The responsiveness of the plunger can therefore increase, while the precision of the injection amount can also be further increased.

The fuel injection device having the above constitution may have a second yoke arranged outside the tubular yoke and the coil, the second coil being provided in a range not protruding beyond the tubular yoke in the axial direction of the tubular yoke.

In such a constitution, the second yoke (for instance, an outer yoke when the tubular yoke is an inner yoke) is set to have a length in the axial direction equal to or shorter than that of the tubular yoke, which as a result allows setting a shorter overall magnetic path length, reducing magnetic loss, and further enhancing the generated magnetic force (thrust). The responsiveness of the plunger can therefore increase, while the precision of the injection amount can also be further increased.

In the fuel injection device having the above constitution, the return channel may be provided inside the tubular yoke.

Compared with the conventional case, in which the return channel is provided between the yoke and the coil, in the present constitution the yoke and the coil can be arranged closer to each other, which in turn allows shortening the magnetic path, curbing magnetic loss, and increasing further the generated electromagnetic force (thrust).

In the fuel injection device having the above constitution, the return channel may be formed so as to run through the interior of the armature in the axial direction.

Such a constitution allows ensuring a maximum sliding surface upon sliding of the armature over the inner peripheral face of the yoke, thereby reducing sliding resistance and affording a smoother operation of the armature.

In the fuel injection device having the above constitution, the return channel may be formed so as to reduce the thickness of the outer peripheral face of the armature in the axial direction.

Compared with the case where a through hole is formed in the armature, in the present constitution the return channel is demarcated so as to work in concert with the inner peripheral face of the yoke, which allows simplifying the manufacture of the armature and reducing costs.

In the fuel injection device having the above constitution, the armature and the plunger may be integrally molded from the same material.

Such a constitution molded out of a same material allows reducing, for instance, the number of mounting operations, the parts count and costs.

### EFFECT OF THE INVENTION

The electromagnetic actuator and the fuel injection device having the above constitutions allow thus, for instance, increasing and flattening the electromagnetic force (drive force or thrust), enhancing responsiveness, enhancing productivity, reducing power consumption and carrying out high-precision stable fuel injection, while affording a reduced parts count, a simpler structure, a smaller outline, lower costs and improved assemblability, among other benefits.

### BRIEF DESCRIPTION OF THE DRAWINGS

FIG. 1 is a vertical cross-section diagram illustrating an embodiment of the electromagnetic actuator and the fuel injection device according to the present invention.

FIG. 2 is a vertical cross-section diagram illustrating an embodiment of the electromagnetic actuator and the fuel injection device according to the present invention.

FIG. 3 illustrates an inner yoke that is part of the electromagnetic actuator and fuel injection device illustrated in FIG. 1; FIG. 3(a) is a side view diagram thereof and FIG. 3(b) is a vertical cross-sectional diagram thereof.

FIG. 4 illustrates a plunger and an armature that are parts of the electromagnetic actuator and the fuel injection device illustrated in FIG. 1; FIG. 4(a) is a plan view diagram thereof, FIG. 4(b) is a side view diagram thereof, FIG. 4(c) is a vertical cross-sectional diagram across E1-E1 in FIG. 4(a), and FIG. 4(d) is a vertical cross-sectional diagram across E2-E2 in FIG. 4(a).

FIG. 5 illustrates a magnetic path and the flow of magnetic force lines in the electromagnetic actuator illustrated in FIG. 1; FIG. 5(a) is a schematic diagram of the armature in a rest position, and FIG. 5(b) is a schematic diagram of the armature in a maximum stroke position.

FIG. 6 is a graph illustrating stroke versus thrust in the armature and plunger of the electromagnetic actuator and the fuel injection device illustrated in FIG. 1.

FIG. 7 is a schematic diagram illustrating the fuel injection device of FIG. 1 installed in an engine.

FIG. 8 is a vertical cross-section diagram illustrating another embodiment of the electromagnetic actuator and the fuel injection device according to the present invention.

FIG. 9 is a vertical cross-section diagram illustrating another embodiment of the electromagnetic actuator and the fuel injection device according to the present invention.

FIG. 10 illustrates a plunger and an armature that are parts of the electromagnetic actuator and the fuel injection device illustrated in FIG. 8; FIG. 10(a) is a plan view diagram thereof, FIG. 10(b) is a side view diagram thereof, and FIG. 10(c) is a vertical cross-sectional diagram across E3-E3 in FIG. 10(a).

FIG. 11 illustrates a magnetic path and the flow of magnetic force lines in the electromagnetic actuator illustrated in FIG. 8; FIG. 11(a) is a schematic diagram of the armature in a rest position, and FIG. 11(b) is a schematic diagram of the armature in a maximum stroke position.

### DESCRIPTION OF THE REFERENCE NUMERALS

E engine
FT fuel tank
FH feed hose
RH return hose
L axial direction
100 plunger pump
110,110′ plunger
111 thickness-reduced portion (return channel)
120,120′ armature
121 through-channel (return channel)
121′ thickness-reduced portion (return channel)
122 annular diameter-reducing portion
130 inner yoke (tubular yoke)
131 outer peripheral face
132 inner peripheral face
132′ inner peripheral face (wall face) demarcating the bottom of the annular gap groove
133 annular gap groove
134 mating portion
135 mating hole
140 channel member
141 through-channel
141a,141b through-hole
142,143 recess
144 joining portion
144a tubular portion
145 outer peripheral face
146,147 annular flange
148 mating recess
149 thickness-reduced portion (return channel)
150 return spring
160 return pipe
170 bobbin
180 excitation coil
190 outer yoke (second yoke)
191 upper yoke
192 lower yoke
193 vertical yoke
200 case
201 supply pipe
201a supply channel
202 connector
203,204 inner peripheral face
210 filter member
220 inlet check valve
230 spill valve
300 injection nozzle
310 nozzle body
311 discharge channel
320 check valve
330 poppet valve

### BEST MODE FOR CARRYING OUT THE INVENTION

Embodiments of the present invention are explained below with reference to accompanying drawings.

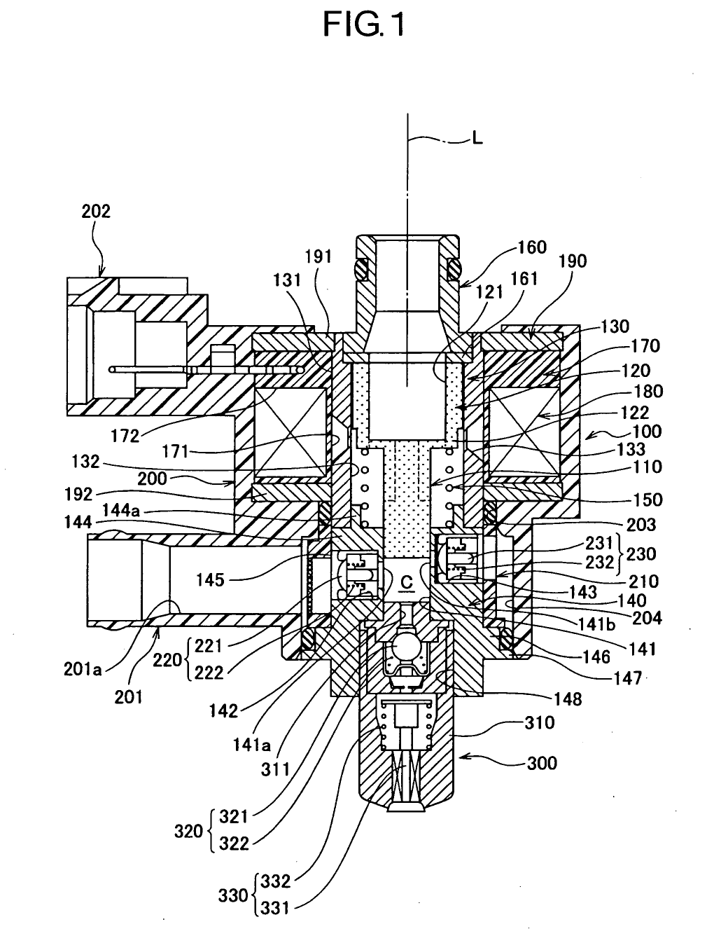

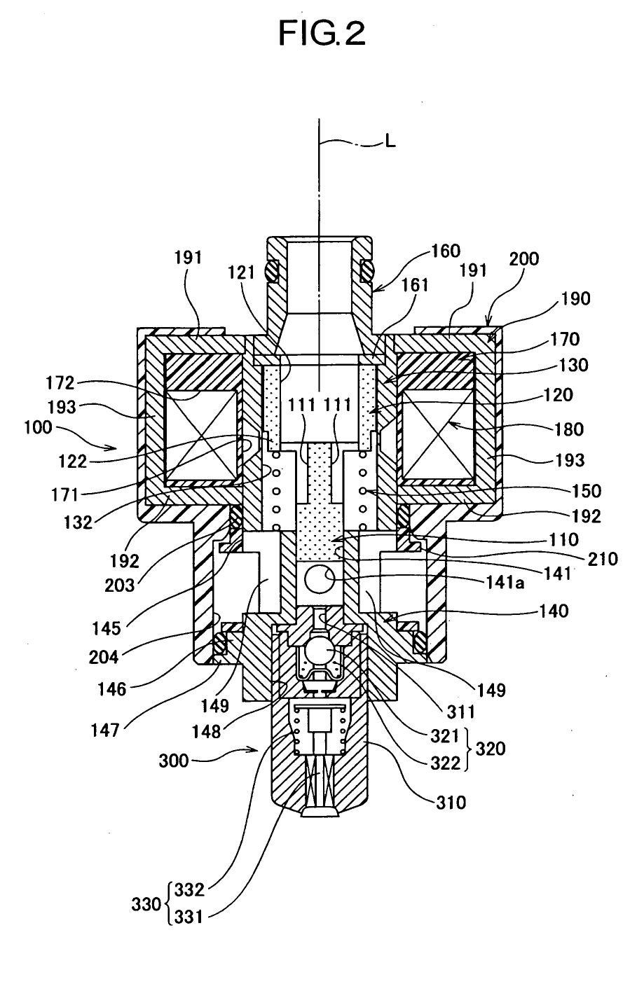

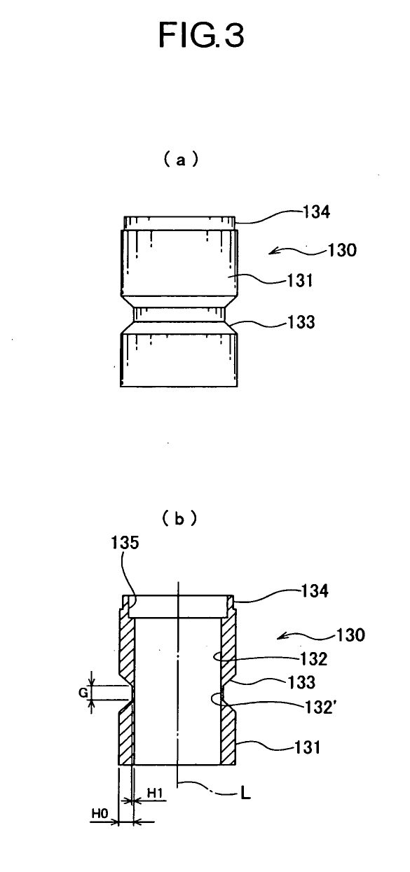

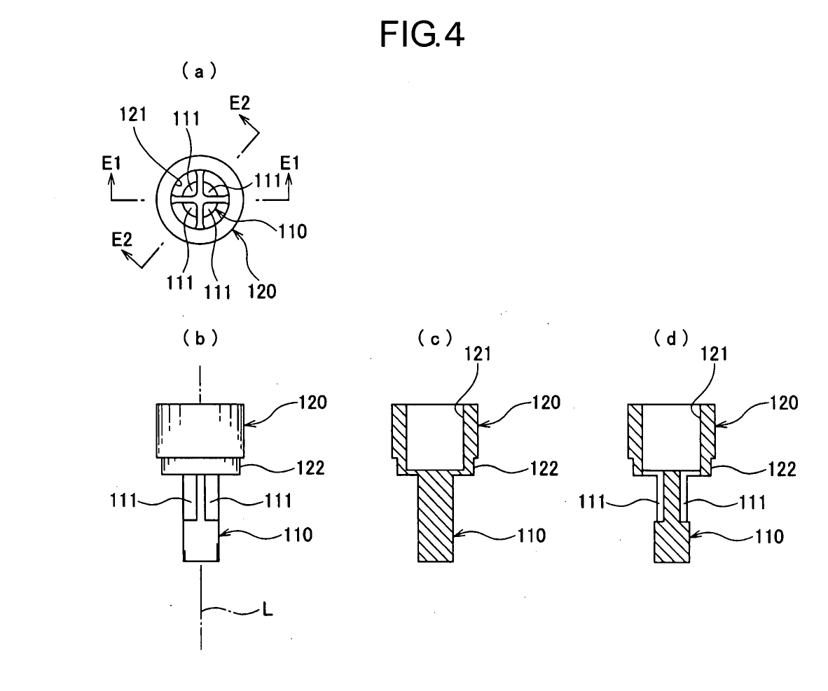

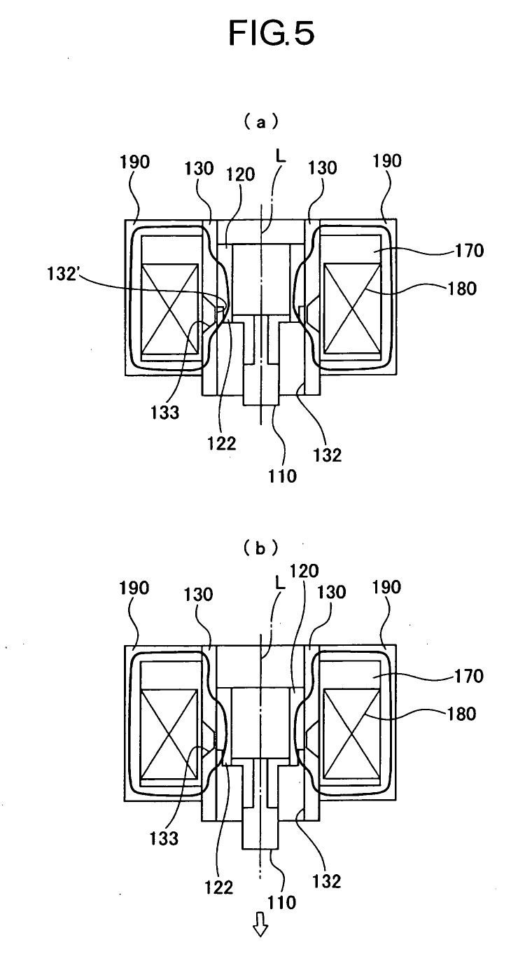

FIGS. 1 to 5 are diagrams illustrating an embodiment of a fuel injection device having as a driving source an electromagnetic actuator according to the present invention; FIGS. 1 and 2 are vertical cross-sectional diagrams of a device; FIG. 3 is a side view diagram and a vertical cross section diagram illustrating a tubular yoke; FIG. 4 is a plan view diagram, a side view diagram and a vertical cross-section diagram illustrating an armature and a plunger; and FIG. 5 is a schematic diagram illustrating the flow of magnetic field lines of the electromagnetic actuator.

As illustrated in FIGS. 1 and 2, the fuel injection device comprises, for instance, a plunger pump 100, as a drive source of an electromagnetic actuator, for pressure-feeding fuel, and an injection nozzle 300 for injecting fuel pressurized at or above a predetermined pressure.

As illustrated in FIGS. 1 and 2, the plunger pump 100 comprises, for instance, a plunger 110 moving reciprocally in the up-and-down direction (axial direction L), an armature 120 formed integrally with the plunger 110, a tubular inner yoke 130, a channel member 140 mating with the lower end of the inner yoke 130 and forming a channel, a return spring 150 for returning the armature 120 (and the plunger 110) to an upper rest position, a return pipe 160 joined to the upper end of the inner yoke 130, a bobbin 170 mating around the periphery of the inner yoke 130, an excitation coil 180 wound on the bobbin 170, an outer yoke 190, as a second yoke, formed extending from the upper end to the lower end of the bobbin 170, a resin-made case 200, molded so as to cover the coil 180 and in which are formed a supply pipe 201 and a connector 202 for electrical connection, a filter member 210 fitting around the channel member 140, and an inlet check valve 220 and a spill valve 230 arranged in the channel member 140.

The electromagnetic actuator for reciprocally driving the plunger 110 comprises, for instance, the armature 120, the inner yoke 130 as a tubular yoke, the bobbin 170 and the coil 180, the outer yoke 190 as a second yoke, the return spring 150 and the like.

As illustrated in FIGS. 1, 2 and 4, the plunger 110 is formed integrally with the armature 120 using a magnetic stainless steel material, and is shaped as a solid cylinder in such a way so as to slidably fit with a below-described through-channel 141 of the channel member 140; the plunger 110 has also formed, on the upper region thereof, thickness-reduced portions 111 extending in the axial direction L.

There are four thickness-reduced portions 111, formed equidistantly on the peripheral direction, demarcating parts of the return channel.

The plunger 110 moves integrally with the below-described armature 120, and performs an intake stroke of fuel aspiration, when returning to an upper rest position in a pressure-feeding chamber C demarcated in the lower portion of the through-channel 141, and a pressure-feeding stroke for compressing and pressure-feeding the fuel of the pressure-feeding chamber C, during a downward travel.

As illustrated in FIGS. 1, 2 and 4, the armature 120 is formed integrally with the plunger 110 using a magnetic stainless steel material, and is shaped as a tube so as to slidably fit with the inner peripheral face 132 of the below-described inner yoke 130; the armature 120 comprises, on the inside thereof, a through-channel 121 that demarcates a part of the return channel, and an annular diameter-reducing portion 122 formed protruding at the lower end of the armature 120, for reducing the diameter of the latter.

The annular diameter-reducing portion 122 is formed in such a way that, when the armature 120 (and the plunger 110) is in the upper rest position, as illustrated in FIGS. 1 and 2, the outer peripheral face of the annular diameter-reducing portion 122 stands opposite, with a predetermined gap in between, the inner peripheral face (wall face) 132′ that demarcates the bottom of an annular gap groove 133 of the below-described inner yoke 130.

In the rest position, therefore, providing the annular diameter-reducing portion 122 facing the inner peripheral face (wall face) 132′ that demarcates the bottom of the annular gap groove 133 of the inner yoke 130, with a slight gap from the inside, allows further suppressing magnetic loss and increasing the generated electromagnetic forces (thrust), and allows enhancing the responsiveness of the plunger 110.

Since the armature 120 and the plunger 110 are integrally molded from the same material, the number of assembly operations, the parts count and overall costs can be reduced, among other benefits.

As illustrated in FIGS. 1 to 3, the inner yoke 130 is formed, using a magnetic material functioning as a magnetic path, to a tubular shape that demarcates an outer peripheral face 131 and an inner peripheral face 132; herein, the inner yoke 130 comprises, for instance, in a substantially central region of the axial direction L thereof, an annular gap groove 133 where the wall thickness is reduced over part of the outer peripheral face 131, the thickness-reduced portion having a trapezoidal cross section widening outwards; a mating portion 134 having a slightly reduced diameter, for joining with the outer yoke 190, on the outer periphery of the upper end of the inner yoke 130; and a mating hole 135 for mating with the return pipe 160, on the inner periphery of the upper end of the inner yoke 130, the mating hole 135 having a slightly widened diameter.

The outer peripheral face 131 is formed so as to fit closely with a through-channel 171 of the below-described bobbin 170. The inner peripheral face 132 is formed so as to be in close contact with the armature 120 and guide the latter slidably in the axial direction L.

The annular gap groove 133 is formed in such a way that, as illustrated in FIG. 3(b), when the wall thickness H0 from the outer peripheral face 131 to the inner peripheral face 132 is of about 2 mm, the wall thickness H1 of the bottom of the annular gap groove 133 is of about 0.3 mm, i.e., in such a way that the wall thickness of the bottom is about 15 percent of the overall thickness. The length G of the bottom of the annular gap groove 133 in the axial direction L is suitably set in accordance with the stroke of the armature 120 and the plunger 110 (displacement from the rest position to the maximum travel end).

The inner yoke 130, thus, is not split into two parts completely separated, with the air gap in between, as in a conventional case, but, through the use of the annular gap groove 133 having a thin-walled bottom, is formed as one component, which allows reducing the parts count, the number of assembly operations, or simplifying management processes. Also, the magnetic path can be shortened, while the electromagnetic force (thrust) generated for the displacement of the armature 120 can be increased and flattened, by forming the annular gap groove 133 so as to demarcate a tapered surface widening outwards, by forming the annular diameter-reducing portion 122 in the armature 120, and by slidably supporting the armature 120 directly on the inner peripheral face 132. The foregoing allows increasing the acceleration (responsiveness) of the armature 120 and the plunger 110.

As illustrated in FIG. 1 and FIG. 2, the channel member 140 is formed of a non-magnetic stainless steel material, and comprises a through channel 141 having a circular cross section and in which the plunger 110 slidably fits; a through-hole 141a running through in the radial direction from the inner face of the through-channel 141; a through hole 141b positioned more upward than the through-hole 141a and running through in the radial direction from the inner face of the through-channel 141; a recess 142 on the outside of the through-hole 141a, for mounting the inlet check valve 220; a recess 143 on the outside of the through-hole 141b, for mounting the spill valve 230; a joining portion 144 having on the upper end a tubular portion 144a for mating with the lower end of the inner yoke 130; an outer peripheral face 145 that fits with the filter member 210; an annular flange 146 for supporting the filter member 210, an annular flange 147 that fits with and supports an O-ring; a mating recess 148 having a circular cross-section, for mating with and fixing the injection nozzle 300; and a plurality of carved-out thickness-reduced portions 149 extending in the up-and-down direction, as the return channel for guiding fuel having passed through the filter member 210 into the upper inner yoke 130.

In the vicinity of the region where the through-holes 141a and 141b of the through-channel 141 are provided, the channel member 140 demarcates the pressure-feeding chamber C for aspirating and pressurizing fuel.

The inlet check valve 220 is mounted on the recess 142, while the spill valve 230 is mounted on the recess 143.

The channel member 140 is formed of a non-magnetic stainless steel material, and hence the magnetic force lines, generated as a result of current flowing through the coil 180, can be blocked and prevented from flowing into this region, and can be made to flow within the short magnetic path formed by the inner yoke 130 and the below-described outer yoke 190.

As illustrated in FIGS. 1 and 2, the return spring 150, which is mounted compressed with a predetermined compression tolerance, is a compression-type coil spring housed in the lower space of the inner yoke 130, the upper end of the return spring 150 abutting the lower face of the annular diameter-reducing portion 122 of the armature 120, the lower end abutting the joining portion 144 on the inside of the tubular portion 144a of the channel member 140.

The return spring 150 allows the armature 120 (and the plunger 110) to move downwards when current passes through the coil 180, and urges the armature 120 (and the plunger 110) upwards back to the rest position when no current flows through the coil 180.

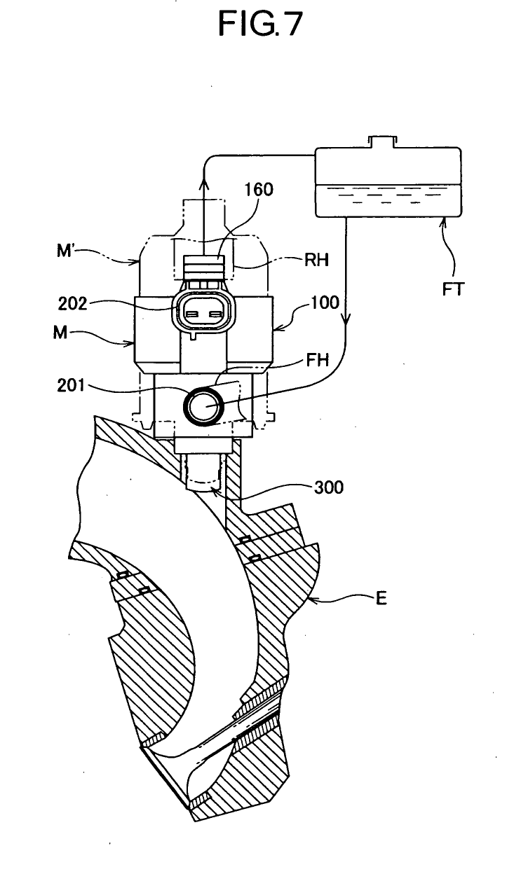

The return pipe 160 demarcates a return channel to a source (the fuel tank FT) for excess fuel and generated vapor, and is connected to a return hose RH, as illustrated in FIG. 7; the return pipe 160 flanks a stopper 161 for stopping the armature 120 at the rest position, and fits with the mating hole 135 of the inner yoke 130.

As illustrated in FIGS. 1 and 2, the bobbin 170 is formed, using a resin material, in such a way so as to demarcate the through-channel 171 having a central circular cross section, and an annular groove 172 of rectangular cross section on the outer peripheral face.

As illustrated in FIGS. 1 and 2, the inner yoke 130 mates with the through-channel 171, to be mounted thereon, while the excitation coil 180 is wound around the annular groove 172.

The outer yoke 190, as illustrated in FIGS. 1 and 2, is formed using a magnetic material functioning as a magnetic path, so as to demarcate an upper yoke 191 and a lower yoke 192 that flank the bobbin 170 in the up-and-down direction, and two vertical yokes 193 extending in the up-and-down direction (axial direction L) and which connect the upper yoke 191 and the lower yoke 192. The length of the vertical yokes 193 is set so that these do not protrude in the axial direction L beyond the inner yoke 130 (equal or shorter length).

The upper yoke 191 mates with the mating portion 134 of the inner yoke 130, to be joined to the latter, while the lower yoke 192 mates with the outer peripheral face 131 of the inner yoke 130, to be joined to the latter.

Compared to a conventional case, this affords as a result a shorter length of the magnetic path formed by the inner yoke 130 and the outer yoke 190, allows suppressing magnetic loss, and allows further enhancing the generated magnetic force (thrust). The responsiveness of the plunger 110 can thereby increase, while the precision of the injection amount by the injection nozzle 300 can also be further increased thereby.

The case 200, in which the bobbin 170 having the coil 180 wound therearound and the outer yoke 190 are in an integrally assembled state, is molded using a resin and, as illustrated in FIGS. 1 and 2, comprises, for instance, a supply pipe 201 that demarcates a supply channel 201a for supplying fuel, a connector 202, an inner peripheral face 203 for fitting an O-ring and having a larger diameter than the outer peripheral face 131 of the inner yoke 130, and an inner peripheral face 204 for fitting an O-ring, having larger diameter than the inner peripheral face 203, and demarcating the wall faces of the return channel by mating with the tubular member 140.

As illustrated in FIG. 7, the supply pipe 201 is connected to the feed hose FH so as to supply fuel from the fuel tank FT.

On the filter member 210, which is formed using a resin material, is mounted a filter for separating foreign matter such as dirt and the like or vapor; as illustrated in FIGS. 1 and 2, the filter member 210 is shaped so as to fit the outer peripheral face 145 of the tubular member 140, the lower end of the filter member 210 being supported by the annular flange 146, and in such a way that the upper end of the filter member 210 pushes the O-ring that fits with the inner peripheral face 203.

As illustrated in FIG. 1, the inlet check valve 220, which is mounted on the recess 142 of the channel member 140, is formed, for instance, by a valve body 221 having a substantially semispherical head, and a compression-type spring 222 for urging the valve body 221 in the valve-closing direction.

During the intake stroke by the plunger 110, the inlet check valve 220 allows the flow of fuel, at or above a predetermined pressure, into the pressure-feeding chamber C via the through-hole 141a, while during the pressure-feeding stroke of the plunger 110, the inlet check valve 220 restricts the outflow of fuel out of the through-hole 141a to the exterior (the supply channel 201a or the thickness-reduced portions 111 as the return channel).

As illustrated in FIG. 1, the spill valve 230 is mounted on the recess 143 of the channel member 140, and is formed, for instance, by a valve body 231 having a substantially semispherical head, and a compression-type spring 232 for urging the valve body 231 in the valve-closing direction.

During the intake stroke by the plunger 110, the spill valve 230 restricts the flow of fuel into the pressure-feeding chamber C via the through-hole 141b, while in the initial region of the pressure-feeding stroke of the plunger 110, the spill valve 230 allows the outflow of fuel or generated vapor out of the through-hole 141b to the exterior (return channel).

In the above constitution, the return channel through which excess fuel or the generated vapor returns to the fuel tank FT is demarcated by the thickness-reduced portions 111 of the plunger 110, the through-channel 121 of the armature 120, and by the space delimited by the thickness-reduced portions 149 of the channel member 140 and the inner peripheral face 132 of the inner yoke 130.

That is, part of the fuel supplied out of the supply channel 201a flows from the inlet check valve 220 into the pressure-feeding chamber C, via the filter member 210, during the intake stroke by the plunger 110, while excess fuel and vapor generated on the upstream side of the filter member 210 are led to the return pipe 160 via the return channel (the thickness-reduced portions 111, the through-channel 121 and the space delimited by the thickness-reduced portions 149 and the inner peripheral face 132), after which the excess fuel and the vapor are returned to the fuel tank FT via the return hose RH.

Compared with a conventional case, in which the return channel is provided between the inner yoke and the coil, herein the return channel is provided so as to pass by the inside of the tubular inner yoke 130; this allows arranging the inner yoke 130 and the coil 180 closer to each other, which in turn allows shortening the magnetic path, curbing magnetic loss, and further increasing the generated electromagnetic force (thrust).

Herein, moreover, part of the return channel is formed as the through-channel 121 that runs through the interior of the armature 120 in the axial direction L; this allows, as a result, ensuring a maximum sliding surface upon sliding of the armature 120 over the inner peripheral face 132 of the inner yoke 130, reducing sliding resistance and affording a smoother operation of the armature 120.

As illustrated in FIGS. 1 and 2, the injection nozzle 300 comprises, for instance, a tubular-shaped nozzle body 310 that fits with the through-channel 141 and the mating recess 148 of the channel member 140; a discharge channel 311 formed on the lower end of the pressure-feeding chamber C; a check valve 320 (i.e., a valve body 321, and a spring 322 for urging the valve body 321 in the valve-closing direction) for allowing only outflow from the discharge channel 311; and a poppet valve 330 (i.e., a poppet valve body 331 and a spring 332 that urges the poppet valve body 331 in the valve-closing direction) that closes when the fuel is at or above a predetermined pressure.

As illustrated in FIG. 7, the injection nozzle 300 is inserted so as to become exposed to the interior of the intake channel of the engine E.

The operation of the above device is explained next.

Firstly, with the armature 120 (and the plunger 110) in the rest position, when current passes through the coil 180, magnetic field lines flow inside the magnetic path formed by the upper side of the inner yoke 130, the armature 120 and the annular diameter-reducing portion 122, the lower side of the inner yoke 130, and the outer yoke 190, as illustrated in FIG. 5(a), whereby the pressure-feeding stroke starts as the plunger 110 that is in the rest position begins to move downward, against the urging force of the return spring 150, to pressurize the fuel inside the pressure-feeding chamber C.

In this initial region of the pressure-feeding stroke, when the pressure-fed fuel acquires a pressure (pressurization) equal to or higher than a predetermined pressure, the spill valve 230 opens, and the fuel mixed with vapor is discharged toward the return pipe 160 via the return channel (thickness-reduced portions 149 and 111, through-channel 121).

Next, when as a result of its further displacement the plunger 110 reaches the latter stage of the pressure-feeding stroke, the side face of the plunger 110 blocks the through-hole 141b whereupon, simultaneously, the pressure of the fuel inside the pressure-feeding chamber C rises further.

At the point in time where the fuel inside the pressure-feeding chamber C rises to a predetermined pressure, the check valve 320 opens, and the fuel at or above the predetermined pressure is injected into the intake channel of the engine E simultaneously with the opening of the poppet valve 330.

Herein, as illustrated in FIG. 5(b), the magnetic field lines flow inside the magnetic path formed by the upper side of the inner yoke 130, the armature 120 and the annular diameter-reducing portion 122, the lower side of the inner yoke 130, and the outer yoke 190, even at the time when the plunger 110 reaches the maximum stroke, as illustrated in FIG. 5(b); as a result, this allows curbing magnetic loss, obtaining a large and substantially flat thrust from the beginning of the movement, and allows the plunger 110 to move at a high speed.

On the other hand, when the current passing through the coil 180 is shut off after fuel injection, the plunger 110 and the armature 120 begin to move upward as a result of the urging force of the return spring 150. Thereupon, the inlet check valve 220 opens, the intake stroke begins, and the fuel inside the supply channel 201a is aspired into the pressure-feeding chamber C via the filter member 210.

Vapor generated in the fuel is actively separated then by the filter member 210, and is discharged towards the return channel (thickness-reduced portions 149 and 111, through-channel 121).

Injection of fuel through the injection nozzle 300 is carried out by consecutively repeating the series of operations comprising the pressure-feeding stroke and the intake stroke by the plunger pump 100.

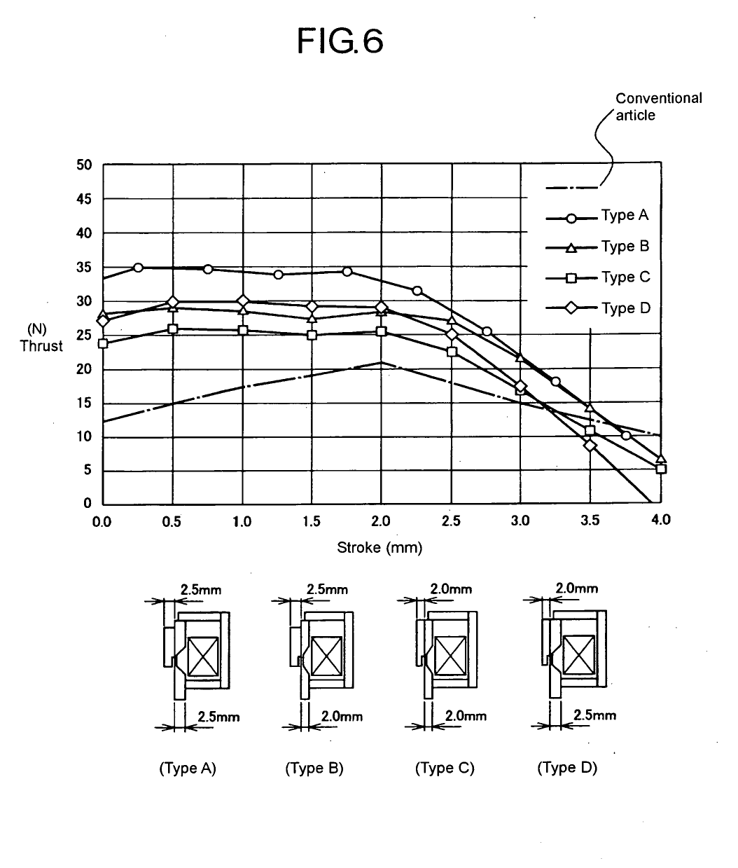

In the fuel supply device having the above electromagnetic actuator as a drive source, thus, the inner yoke 130 is not split in two, as in a conventional case, but is formed as one component, with the air gap formed as the annular gap groove 133 of trapezoidal cross section on the outer peripheral face 131 of the inner yoke 130, while, in addition, the armature 120 is slidably supported directly on the inner peripheral face 132 of the inner yoke 130; as a result, this allows shortening the magnetic path while reducing the parts count and, as illustrated in FIG. 6, allows increasing and flattening the electromagnetic force (thrust) generated for the displacement of the armature 120.

The foregoing allows increasing the acceleration (responsiveness) of the armature 120 and the plunger 110. Therefore, if the discharge characteristic is good as in a conventional case, power consumption can be reduced by shrinking the drive pulse width, while, on the other hand, discharge (injection) precision can be increased by setting a drive pulse width as in a conventional case. Since thrust is flattened in the range of motion of the armature 120 (and the plunger 110), there is no need to perform high-precision control of the relative assembly positions of the armature 120 and the inner yoke 130; this allows, for instance, simplifying the assembly operations as well as reducing costs.

As illustrated in FIG. 7, also, the fuel supply device M having the above electromagnetic actuator as a drive source is smaller than a conventional fuel supply device M′; this increases the degree of freedom for mounting on the engine E, and allows reducing the height of the supply pipe 201 vis-à-vis a conventional case, which in turn allows securing sufficient head difference from the supply pipe 201 to the fuel tank FT, affording thereby a stable fuel supply.

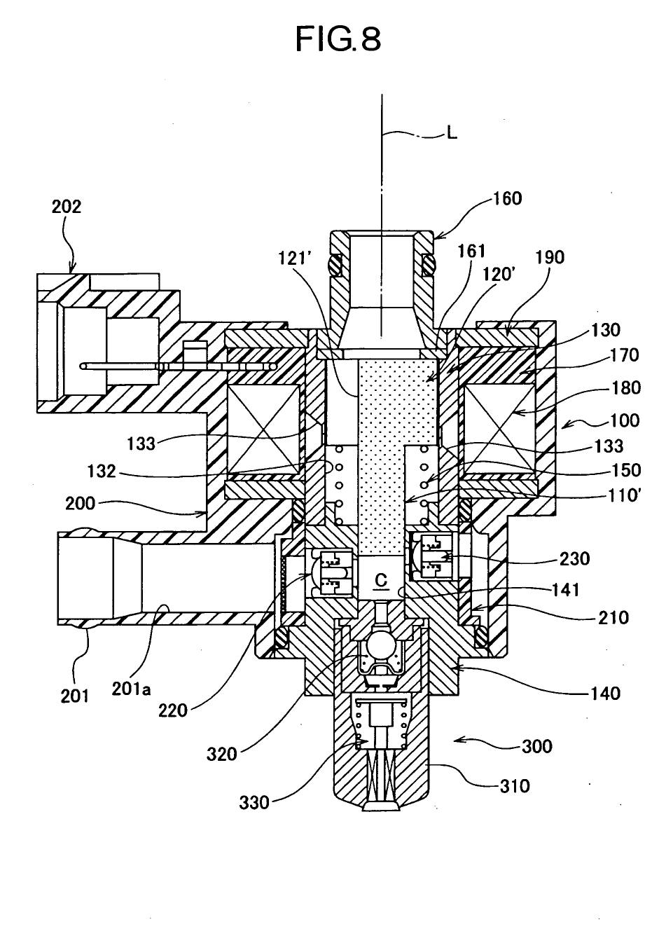

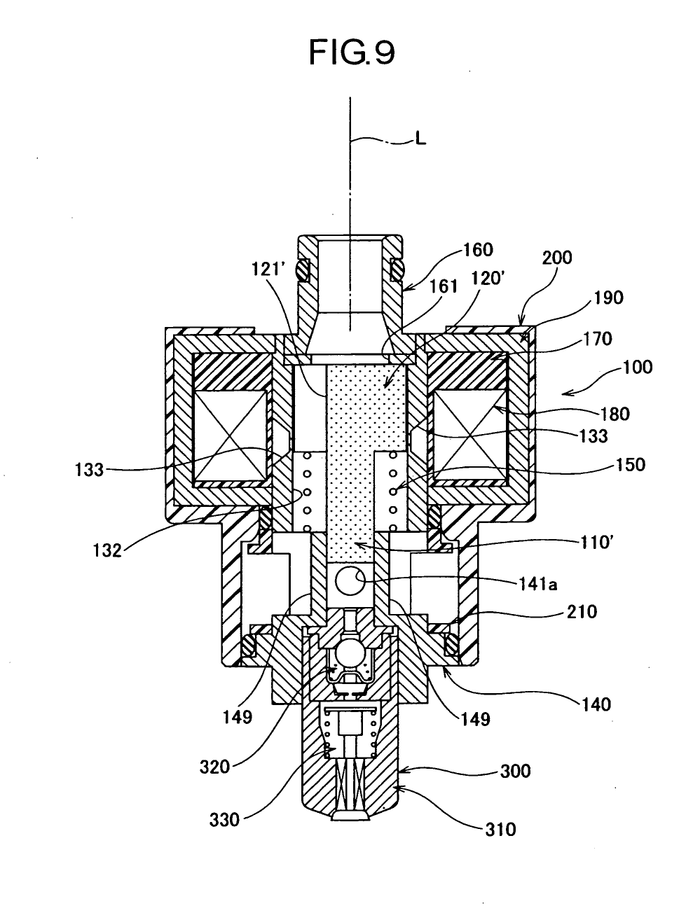

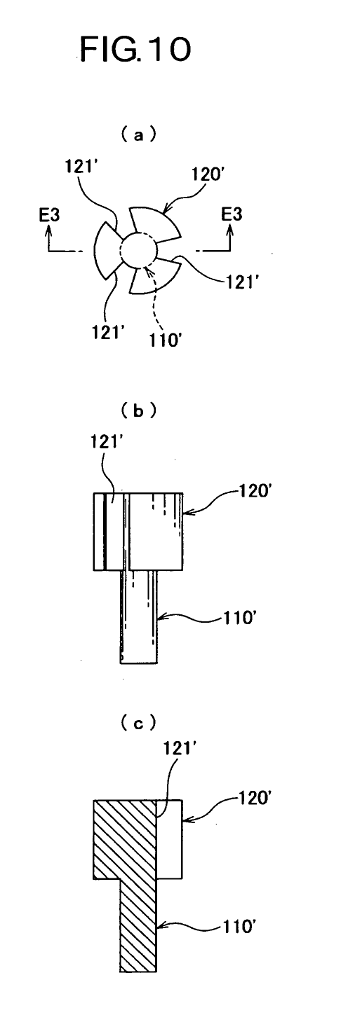

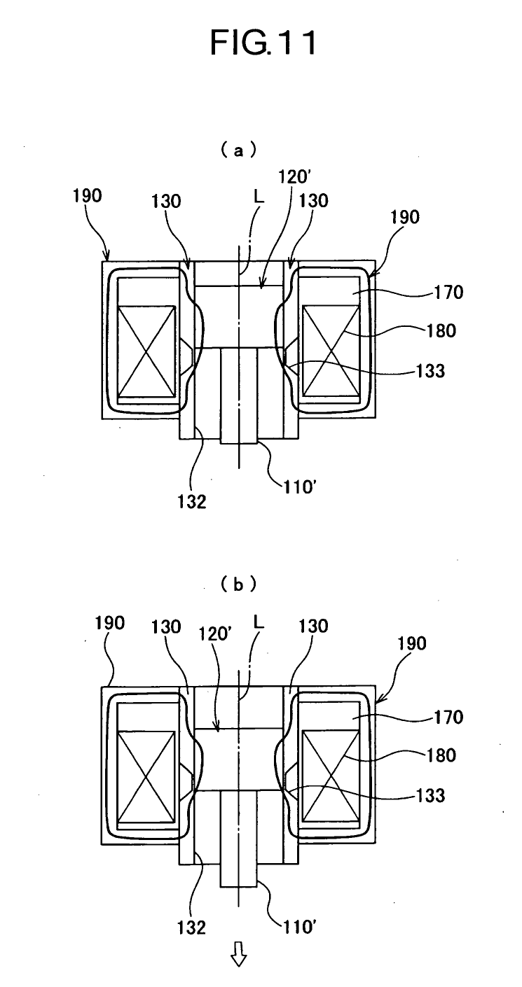

FIGS. 8 to 11 are diagrams illustrating another embodiment of an electromagnetic actuator and a fuel supply device according to the present invention; FIGS. 8 and 9 are vertical cross-sectional diagrams of the device; FIG. 10 is a plan view diagram, a side view diagram and a vertical cross section diagram illustrating an armature and a plunger; and FIG. 11 is a schematic diagram illustrating the flow of magnetic field lines of the electromagnetic actuator.

Except for the modified armature 120′ and the plunger 110′, the present embodiment is identical to the above-described embodiment, and hence identical constitutions are denoted with identical reference numerals, the explanation whereof is omitted.

In this device, thus, as illustrated in FIGS. 8 to 10 the plunger 110′ is shaped as a solid cylinder, integrally with the armature 120′, using a magnetic stainless steel material.

The plunger 110′ moves integrally with the armature 120′, and performs an intake stroke of fuel aspiration when returning to the upper rest position in the pressure-feeding chamber C demarcated in the lower portion of the through-channel 141, and a pressure-feeding stroke for compressing and pressure-feeding the fuel of the pressure-feeding chamber C, during a downward travel.

As illustrated in FIGS. 8 to 10, the armature 120′ is formed integrally with the plunger 110′ using a magnetic stainless steel material; the armature 120′ comprises, on part of the inner outer peripheral face thereof, three carved-out thickness-reduced portions 121′ in the axial direction L.

That is, the return channel in the region of the armature 120′ and the inner yoke 130′ is demarcated by the inner peripheral face 132 of the inner yoke 130 and the thickness-reduced portions 121′ of the armature 120′.

Thus, the return channel is formed by the inside of the inner yoke 130 and the thickness-reduced outer peripheral face of the armature 120′; as a result, this allows simplifying the manufacture of the armature 120′, and reducing costs, compared with the case where the through hole 121 is formed in the armature 120.

Although the armature 120′ is not provided with the above-described annular diameter-reducing portion 122, a short magnetic path is formed herein nonetheless, as illustrated by the rest position of FIG. 11(a) and the maximum stroke position of FIG. 11(b); the short magnetic path that forms allows curbing magnetic force loss and, in consequence, achieving a flat and large thrust, as described above.

Since the armature 120′ and the plunger 110′ are integrally molded from the same material, the number of assembly operations, the parts count and overall costs can all be reduced.

That is, in the fuel supply device according to the present embodiment, similarly to the above-described embodiment, the inner yoke 130 is not split in two, as in a conventional case, but is formed as one component, with the air gap formed as the annular gap groove 133 of trapezoidal cross section on the outer peripheral face 131 of the inner yoke 130, while, in addition, the armature 120′ is slidably supported directly on the inner peripheral face 132 of the inner yoke 130; as a result, this allows shortening the magnetic path while reducing the parts count and allows increasing and flattening the electromagnetic force (thrust) generated for the displacement of the armature 120′.

The foregoing allows increasing the acceleration (responsiveness) of the armature 120′ and the plunger 110′, and allows shortening the time required by the pressurization stroke. Therefore, if the discharge characteristic is good as in a conventional case, power consumption can be reduced by shrinking the drive pulse width, while, on the other hand, discharge (injection) precision can be increased by setting a drive pulse width as in a conventional case.

Also, the device becomes smaller than a conventional fuel supply device M′, and thus increases the degree of freedom for mounting on the engine E, and allows reducing the height of the supply pipe 201 vis-à-vis the conventional case, which in turn allows securing sufficient head difference from the supply pipe 201 to the fuel tank FT, affording thereby a stable fuel supply.

Although the above-described embodiments illustrate instances where the electromagnetic actuator according to the present invention is used as the drive source of a fuel injection device, the invention is not limited thereto, and provided that the plunger moves reciprocally in one direction, drive sources having other mechanics can also be used in the invention.

In the above embodiments is illustrated a case where the plunger 110, 110′ is integrally formed with the armature 120, 120′, but the invention is not limited thereto; for instance, the plunger 110, 110′ may be formed separately, out of a light material, and may be joined thereafter with the armature.

### INDUSTRIAL APPLICABILITY

As explained above, the electromagnetic actuator and the fuel injection device of the present invention allow increasing and flattening the electromagnetic force (drive force or thrust), and enhancing responsiveness, among other benefits, while affording a reduced parts count, a simpler structure, a smaller outline, lower costs and improved assemblability; therefore, the invention can find an obvious application as a fuel injection device in engines of two-wheel vehicles, where size reduction is required, but also in engines mounted in other types of vehicles where no such size reduction requirement applies.

1. An electromagnetic actuator, comprising:
a tubular yoke;
an excitation coil arranged around said yoke; an armature slidably arranged inside said yoke; and
a return spring for returning said armature to a rest position, the electromagnetic actuator driving a plunger integrally with said armature, wherein
said yoke has, at a predetermined position in an axial direction, a thickness-reduced annular gap groove over part of the outer periphery of said yoke, said annular gap groove having a trapezoidal cross section widening outwards.

2. The electromagnetic actuator according to claim 1, wherein said armature has an annular diameter-reducing portion, formed protruding in the axial direction, removed from and facing toward a wall face that demarcates the bottom of said annular gap groove when said armature is in a rest position.

3. The electromagnetic actuator according to claim 1, having a second yoke arranged outside said tubular yoke and coil, wherein
said second yoke is provided in a range not protruding beyond said tubular yoke in the axial direction of said tubular yoke.

4. The electromagnetic actuator according to claim 1, wherein said armature and plunger are integrally molded from the same material.

5. A fuel injection device, comprising:
an electromagnetic actuator having a plunger for aspirating fuel into a pressure-feeding chamber and for pressure-feeding said fuel through a reciprocating motion, a supply channel for feeding said fuel to said pressure-feeding chamber, a return channel for returning part of said supplied fuel, an armature moving integrally with said plunger to electromagnetically drive said plunger, a tubular yoke for slidably housing said armature, an excitation coil arranged around said yoke, and a return spring for returning said armature to a rest position; and
an injection nozzle for injecting said fuel discharged from said pressure-feeding chamber, wherein
said yoke has, at a predetermined position in an axial direction, a thickness-reduced annular gap groove over part of the outer periphery of said yoke, said annular gap groove having a trapezoidal cross section widening outwards.

6. The fuel injection device according to claim 5,
wherein said armature has an annular diameter-reducing portion, formed protruding in the axial direction, removed from and facing toward a wall face that demarcates the bottom of said annular gap groove when said armature is in a rest position.

7. The fuel injection device according to claim 5, having a second yoke arranged outside said tubular yoke and coil, wherein
said second yoke is provided in a range not protruding beyond said tubular yoke in the axial direction of said tubular yoke.

8. The fuel injection device according to claim 5, wherein said return channel is provided inside said tubular yoke.

9. The fuel injection device according to claim 8, wherein said return channel is formed so as to run through the interior of said armature in the axial direction.

10. The fuel injection device according to claim 8, wherein said return channel is formed so as to reduce the thickness of the outer peripheral face of said armature in the axial direction.

11. The fuel injection device according to claim 5, wherein said armature and said plunger are integrally molded from the same material.

12. The electromagnetic actuator according to claim 2, wherein said armature and plunger are integrally molded from the same material.

13. The electromagnetic actuator according to claim 3, wherein said armature and plunger are integrally molded from the same material.

14. The fuel injection device according to claim 6, having a second yoke arranged outside said tubular yoke and coil, wherein
said second yoke is provided in a range not protruding beyond said tubular yoke in the axial direction of said tubular yoke.

15. The fuel injection device according to claim 6, wherein said return channel is provided inside said tubular yoke.

16. The fuel injection device according to claim 7, wherein said return channel is provided inside said tubular yoke.

17. The fuel injection device according to claim 6, wherein said armature and said plunger are integrally molded from the same material.

18. The fuel injection device according to claim 7, wherein said armature and said plunger are integrally molded from the same material.

19. The fuel injection device according to claim 8, wherein said armature and said plunger are integrally molded from the same material.

20. The fuel injection device according to claim 9, wherein said armature and said plunger are integrally molded from the same material.

21. The fuel injection device according to claim 10, wherein said armature and said plunger are integrally molded from the same material.
